(19) United States
(12) Patent Application Publication
(10) Pub. No.: US 2012/0285775 A1
(43) Pub. Date: Nov. 15, 2012

(54) BRAKE PAD WEAR INDICATOR

(76) Inventor: Robert McGee, La Porte, TX (US)

(21) Appl. No.: 13/469,394

(22) Filed: May 11, 2012

Related U.S. Application Data
(60) Provisional application No. 61/485,616, filed on May 12, 2011.

(51) Int. Cl. F16D 66/02; B23P 11/00

(52) U.S. Cl. 188/1.11 W; 29/428

(57) ABSTRACT

One example embodiment includes a brake pad which provides a visual indication when the brake pad requires changing. The brake pad includes a first layer, where the first layer includes a material configured to create friction with an external brake disk connected to a wheel. The brake pad also includes a second layer. The second layer includes the material of the first layer. The second layer also includes a dye, wherein the dye is configured to create a visually identifiable dust on the external brake disk.

### CROSS-REFERENCE TO RELATED APPLICATIONS

This application claims the benefit of and priority to U.S. Provisional Patent Application Ser. No. 61/485,616 filed on May 12, 2011, which application is incorporated herein by reference in its entirety.

### BACKGROUND OF THE INVENTION

Brake pads are an important component in helping vehicles to stop their motion. The brake pad is used to transform the rotational motion of the wheels into heat, thus dissipating the energy used to propel the vehicle. However, this can cause a great deal of wear on the brake pad. When the brake pad becomes significantly worn, it can make it difficult or dangerous to stop the vehicle.

There are electronic sensors that can sense this wear and indicate when the brake pads require changing. However, the sensors have thus far proven unreliable. Additionally, these sensors are only available on newer cars. Many brake pads include a material which makes a squealing noise when the pad wears to a certain level. This noise serves as an indicator that the brakes need changing. However, the noise produced by these materials can be difficult to hear. This is especially true in newer cars which tend to have better sound proofing than older cars.

The brake pads do leave a layer of dust on the brake disks. However, this dust is the same or substantially similar whether produced by a new brake pad or a nearly worn out brake pad. Many users, therefore, are forced to remove one or more of the wheels to visually inspect the brake pad and determine the amount of brake pad wear.

Accordingly, there is a need in the art for a brake pad that can provide a visual indication of when the brake pad needs changing. Further, there is a need for the visual indication to be visible without removing the wheels.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a brake pad which provides a visual indication when the brake pad requires changing. The brake pad includes a first layer, where the first layer includes a material configured to create friction with an external brake disk connected to a wheel. The brake pad also includes a second layer. The second layer includes the material of the first layer. The second layer also includes a dye, wherein the dye is configured to create a visually identifiable dust on the external brake disk.

Another example embodiment includes a system for braking a wheeled vehicle. The system includes a wear surface, wherein the wear surface is attached to a wheel. The system also includes a brake pad. The brake pad includes a first layer, where the first layer includes a material configured to create friction with the wear surface. The brake pad also includes a second layer, where the second layer is substantially similar to the first layer and includes a dye, wherein the dye is configured to create a visually identifiable dust on the wear surface. The system also includes a brake caliper, where the brake caliper is configured to press the brake pad against the wear surface.

Another example embodiment includes a method of manufacturing a brake pad which provides a visual indication when the brake pad requires changing. The method includes providing a first layer, where the first layer includes a material configured to create friction with an external brake disk connected to a wheel. The first layer also includes a visual indicator, wherein the visual indicator is configured to create a visually identifiable dust on the brake disk. The method also includes deposing a second layer. The second layer includes the material of the first layer. The second layer does not include the visual indicator.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a brake system;

FIG. 2A illustrates a perspective view of the example brake pad;

FIG. 2B illustrates a side view of the example brake pad;

FIG. 3 illustrates an example of a brake pad that has undergone moderate wear;

FIG. 4 illustrates an example of a brake pad that has undergone extensive wear;

FIG. 5 illustrates an alternative braking system; and

FIG. 6 is a flow chart illustrating a method of manufacturing a brake pad.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

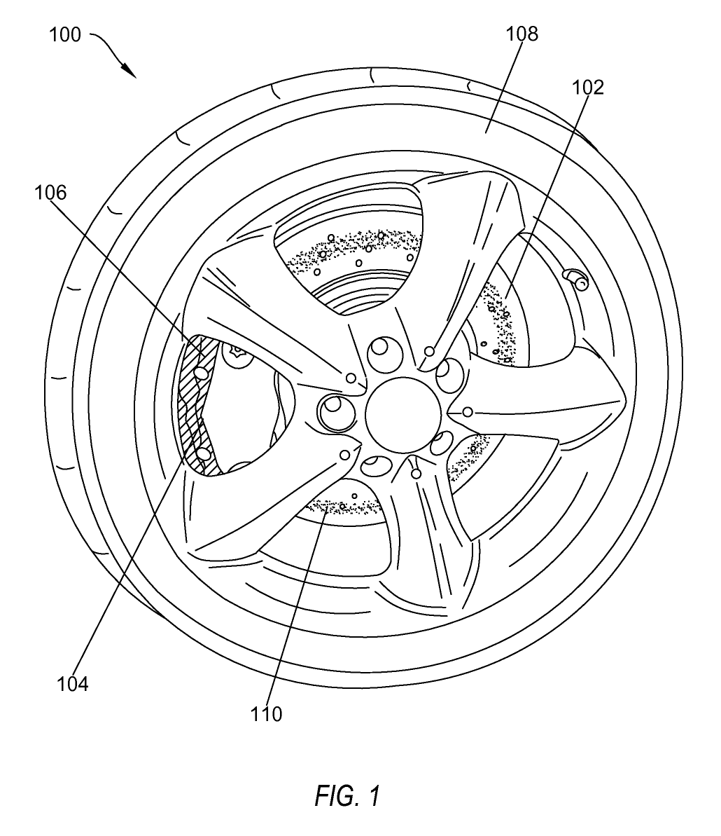

FIG. 1 illustrates an example of a brake system 100. In at least one implementation, the brake system 100 is configured to reduce or eliminate forward momentum in a vehicle. I.e., the brake system allows the vehicle to slow or stop, despite any existing forward momentum.

FIG. 1 shows that the brake system 100 includes a brake disk 102. In at least one implementation, the brake disk 102 can be made of any design and/or material. For example, the brake disk 102 can include solid cast iron. Additionally or alternatively, the brake disk 102 can include hollowed out fins or vanes joining together the disc's two contact surfaces (usually included as part of a casting process). The “ventilated” disc design helps to dissipate the generated heat and is commonly used on the more-heavily-loaded front discs. Additionally or alternatively, the brake disk 102 can include holes drilled through the brake disk 102. Additionally or alternatively, the brake disk 102 can include slots. I.e., shallow channels are machined into the disc to aid in removing dust and gas. One of skill in the art will appreciate that the brake disk 102 can be both drilled and slotted. On the road, drilled or slotted discs still have a positive effect in wet conditions because the holes or slots prevent a film of water building up between the disc and the pads.

FIG. 1 also shows that the brake system 100 can include a brake pad 104. In at least one implementation, the brake pad 104 converts the kinetic energy of the car to thermal energy by friction. In particular, two brake pads 104 are mounted with their friction surfaces facing the brake disk 102. When the brakes are applied, the two brake pads 104 are squeezed together into the spinning brake disk 102 to slow/stop the vehicle. When a brake pad 104 is heated by contact with a brake disk 102, it transfers small amounts of friction material to the brake disk 102, turning it dull gray. The brake pad 104 and disc (both now with friction material), then “stick” to each other, providing the friction that stops the vehicle.

The brake pads 104 must usually be replaced regularly (depending on pad material). In at least one implementation, the brake pads 104 may be equipped with a method of alerting the driver when this needs to take place. For example, the brake pad 104 can include a thin piece of soft metal that causes the brakes to squeal when the pads are too thin. Additionally or alternatively, the brake pad 104 can include a soft metal tab embedded in the brake pad 104 material that closes an electric circuit and lights a warning light when the brake pad 104 gets thin.

FIG. 1 further shows that the brake system 100 can also include a caliper 106. In at least one implementation, the caliper 106 is configured to press the brake pad 104 against the brake disk 102. I.e., the caliper provides the force which keeps the brake pad 104 against the brake disk 102 during a braking operation. The caliper is not in direct contact with the brake disk 102.

FIG. 1 further shows that the brake system 100 can include a wheel 108. In at least one implementation, the wheel 108 is connected to the brake disk 102. I.e., the rate of rotation of the wheel 108 and the disk 102 are directly related to one another, normally at a 1:1 ratio. In at least one implementation, friction between the brake pad 104 and the disk 102 can cause the wheel 108 to slow or stop.

FIG. 1 shows that the brake system 100 can also include a visual indicator 110. In at least one implementation, the brake system 100 can include a visual indicator 110 created by the brake pad 104 when replacement is required. For example, the visual indicator 110 can include a colored dust, as described below. In particular, the color of the visual indicator 110 is configured to get the attention of an observer who looks at the wheel 108. For example, the color of the visual indicator 110 can be bright green, red or some other color which is easily visible. When the brake pad 104 has worn sufficiently, the colored visual indicator 110 is produced, indicating to the observer that the brake pads are ready to be changed. The visual indicator 110 can be visible on the disk 102, the wheel 108 or any other location. In particular, the visual indicator 110 will tend to spread to surrounding areas, making the need for brake replacement visually obvious to the user.

One of skill in the art will appreciate that the brake system 100 can include different configurations. For example, the brake system 100 can include a drum brake, where the brake pads 104 are applied to the interior surface of a drum, rather than the external surfaces of a brake disk 102, as described below. Additionally or alternatively, the brake system 100 can include a clasp brake, where the brake pads 104 are applied to the exterior surface of a drum, rather than the external surfaces of a brake disk 102.

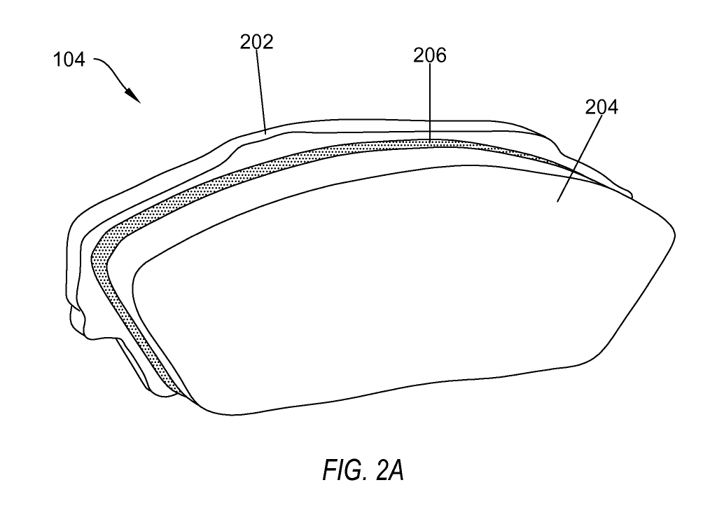

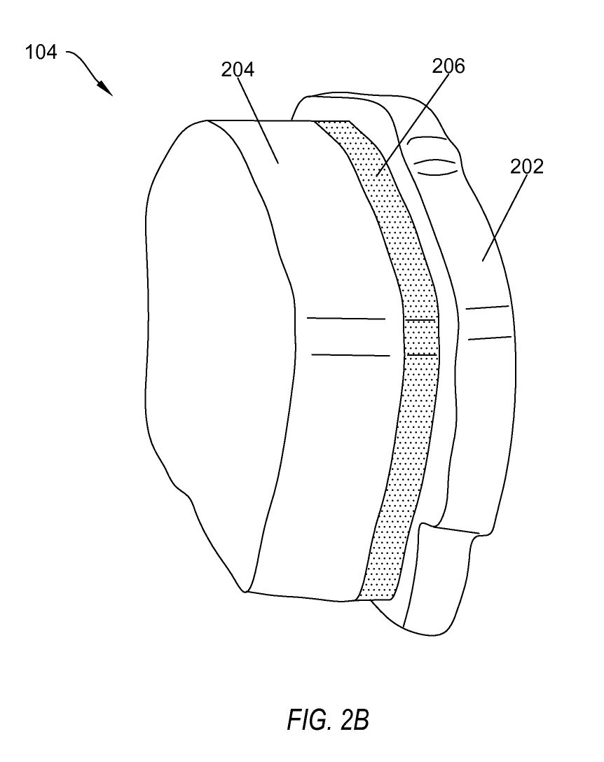

FIGS. 2A and 2B illustrate an example of a brake pad 104. FIG. 2A illustrates a perspective view of the example brake pad 104; and FIG. 2B illustrates a side view of the example brake pad 104. In at least one implementation, the brake pad 104 can be used with disk brakes or drum brakes. A disk brake (or disc brake) is a device for slowing or stopping the rotation of a wheel while it is in motion. In particular, a brake disk (or rotor) is usually made of cast iron, but may in some cases be made of composites such as reinforced carbon-carbon or ceramic-matrix composites. The disk brake is connected to the wheel and/or the axle. To stop the wheel, friction material in the form of brake pad 104 (mounted on a device called a brake caliper) is forced mechanically, hydraulically, pneumatically or electromagnetically against one or both sides of the disk. Friction between the brake disk and the brake pad 104 causes the disk and attached wheel to slow or stop. I.e., the friction between the brake disk and the brake pad 104 converts motion to heat.

FIGS. 2A and 2B show that the brake pad 104 can include an attachment 202. In at least one implementation, the attachment 202 can allow the brake pad 104 to be attached at an appropriate location. For example, the attachment 202 can include a ridge, which allows the brake pad 104 to be secured in place. In particular, the ridge can allow the brake pad 104 to be installed in a desired location. I.e., the ridge can be slid into a complementary trough or can be clamped or otherwise secured with clamps or other mechanisms. Additionally or alternatively, the attachment 202 can include bolt holes, nuts, latches or any other desired attachment mechanism.

FIGS. 2A and 2B show that the brake pad 104 includes a first layer 204. In at least one implementation, the first layer 204 can be made of any suitable material, depending on the intended use of the vehicle, from very soft and aggressive (such as racing applications) and harder, more durable and less aggressive compounds. Most vehicle manufacturers recommend a specific compound of brake pad for their vehicle, but compounds can be changed (by either buying a different make of pad or upgrading to a performance pad in a manufacturer's range) according to personal tastes and driving styles.

FIGS. 2A and 2B further show that the brake pad 104 can include a second layer 206. In at least one implementation, the second layer 206 can be made of material that is the same or substantially similar to the first layer 204 but can be a different color than the first layer 204. In particular, the second layer 206 can include a colored substance or dye. The dye can change the color of one or more of the substances in the second layer 206.

One of skill in the art will further appreciate that the brake pad 104 can include more than two layers. For example, the brake pad 104 could include three layers. The second layer can be dyed a first color and the third layer can be dyed a second color. The first color can indicate to the user that the brake pad 104 is nearing replacement. In contrast, the second color can indicate to the user that the brake pad 104 needs to be replaced as soon as possible.

One of skill in the art will appreciate that the dye can be added to the brake pad using a method other than dyeing the second layer 206. For example, the dye can be stored in cylinders or holes within the second layer 206, such that when the first layer 204 has been sufficiently worn, the dye will be released and become visible. I.e., any method of releasing a colored dye when the first layer 204 has been worn away is contemplated herein.

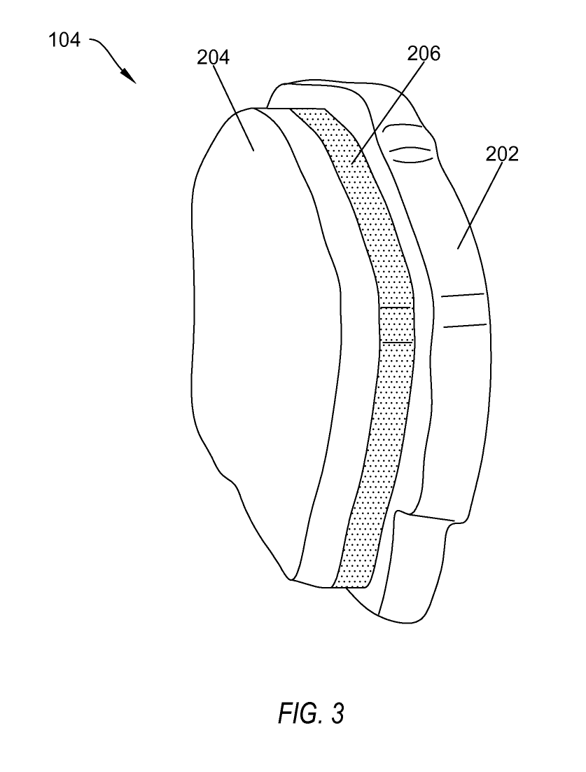

FIG. 3 illustrates an example of a brake pad 104 that has undergone moderate wear. In at least one implementation, the brake pad 104 is configured to wear during use. I.e., the brake pad is configured to break down, creating a dust. This dust increases the coefficient of friction and thus the effectiveness of the brakes. Additionally or alternatively, the brake pad can be more likely to break down than other parts, thus preserving other parts of the braking system.

FIG. 3 shows that a portion of the first layer 204 has been removed. I.e., as the brake pad 104 is pressed against the disk the first layer 204 will wear away. In particular, movement of the disk relative to the brake pad 104 causes minute particles of the first layer 204 to be torn away from the first layer 204. Additionally or alternatively, the friction caused by pressing the brake pad 104 against the disk causes heat, which causes damage on the molecular layer to the first layer 204. This molecular damage causes portions of the first layer 204 to be removed from the brake pad 104.

FIG. 3 also shows that the second layer 206 remains substantially unchanged. I.e., the damage caused by use of the brake pad 104 occurs almost exclusively on the first layer 204. In particular, the surface of the first layer 204 which is pressed against the disk suffers almost all of the wear within the brake pad 104. The second layer 206, in contrast does not receive any damage or wear until the first layer 204 has worn through in one or more areas.

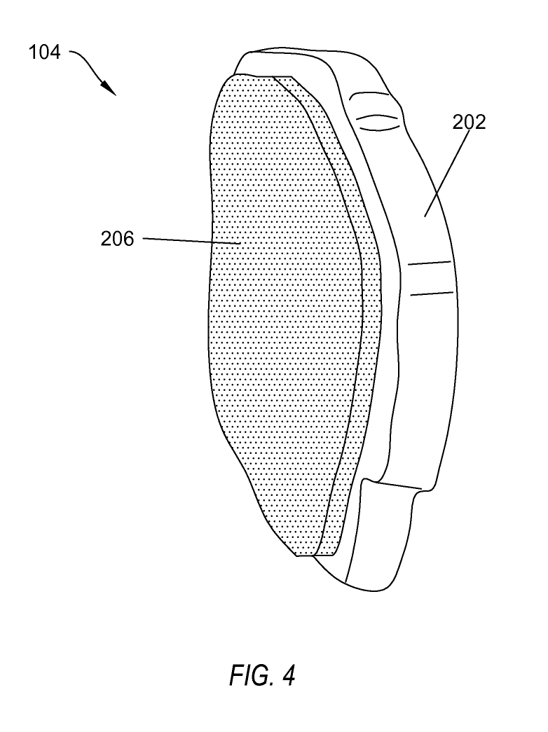

FIG. 4 illustrates an example of a brake pad 104 that has undergone extensive wear. In at least one implementation, the brake pad 104 is configured to wear during use. I.e., the brake pad is configured to break down, creating a dust. This dust increases the coefficient of friction and thus the effectiveness of the brakes. Additionally or alternatively, the brake pad can be more likely to break down, thus preserving other parts of the braking system.

FIG. 4 shows that the entire first layer 204 has been removed. This means that a portion of the second layer 206 has been removed. I.e., as the brake pad 104 is pressed against the disk the second layer 206 will wear away. In particular, movement of the disk relative to the brake pad 104 causes minute particles of the second layer 206 to be torn away from the second layer 206. Additionally or alternatively, the friction caused by pressing the brake pad 104 against the disk causes heat, which causes damage on the molecular layer to the second layer 206. This molecular damage causes portions of the second layer 206 to be removed from the brake pad 104.

In at least one implementation, as the second layer 206 begins to wear it leaves a dust that is a different color or that is readily apparent to the user, indicating the need to change the brake pad, as described below. I.e., the coloring within the second layer 206 means that the dust produced is a color which is visible to the user without removing any parts of the vehicle, producing a visible indicator.

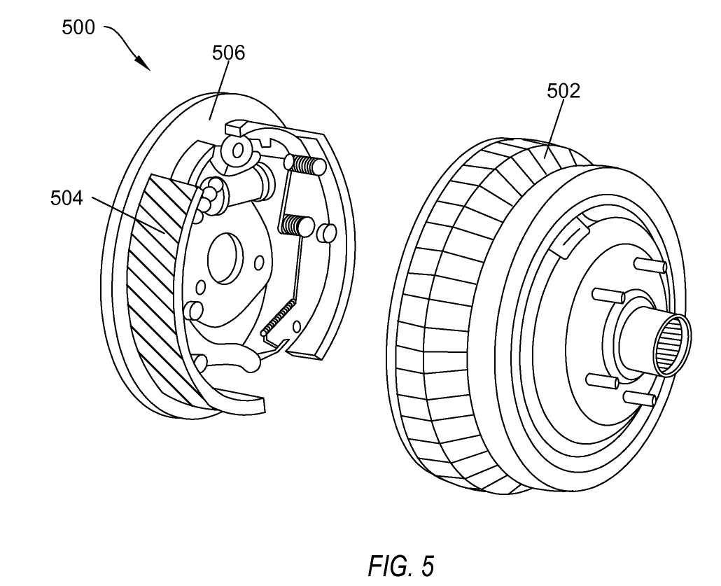

FIG. 5 illustrates an alternative braking system 500. In at least one implementation, the alternative braking system 500 includes a drum braking system. I.e., the braking system 500 includes a system that does not include a brake disk. The alternative braking system 500 can allow for braking in a system in which a brake disk would be unwieldy or ineffective.

FIG. 5 shows that the braking system 500 can include a brake drum 502. In at least one implementation, the brake drum 502 is a rotating cylinder. In particular, the brake drum 502 includes a first surface which can be attached to wheel or other rotating device. The brake drum 502 can also include a wall attached to the first surface. The wall can allow the braking system 500 to stop the rotation of the brake drum 502, as described below.

FIG. 5 also shows that the braking system 500 can include a brake pad 504. In at least one implementation, the brake pad 504 is configured to be pressed against the wall of the brake drum 502. For example, the brake pad 504 can be pressed against the exterior surface of the wall. Additionally or alternatively, the brake pad 504 can be pressed against the interior surface of the wall.

FIG. 5 further shows that the braking system 500 can include a backing plate 506. In at least one implementation, the backing plate 506 can be configured to press the brake pad 504 against the wall of the brake rum 502. I.e., as the braking system 100 is activated, the backing plate 506 forces the brake pad 504 against either the exterior or interior of the wall of the brake drum 502, producing friction which converts the rotation of the brake drum 502 to heat.

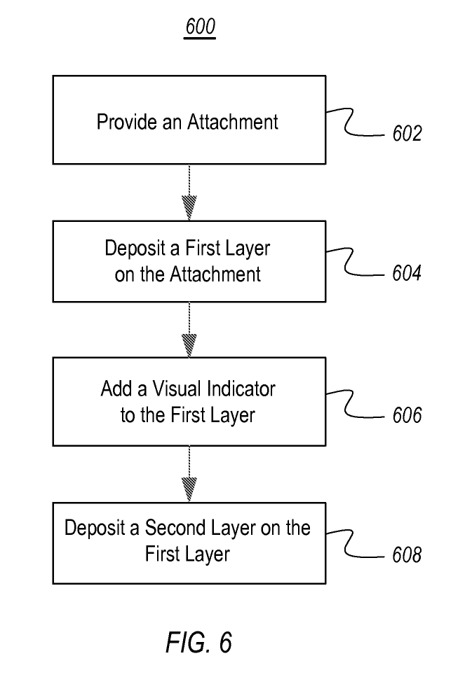

FIG. 6 is a flow chart illustrating a method 600 of manufacturing a brake pad. One of skill in the art will appreciate that the method 600 can be used to produce the brake pad 104 of FIG. 1; however, the method 600 can be used to produce a brake pad other than the brake pad 104 of FIG. 1. In at least one implementation, the method 600 can produce a brake pad that provides a visual indicator of brake pad wear to a user.

FIG. 6 shows that the method 600 can include providing 602 an attachment 602. In at least one implementation, the attachment 602 can include any mechanism for mounting the brake pad in a desired location. For example, the attachment can include a ridge, which allows the brake pad to be secured in place. For example, the ridge can allow the brake pad to be installed in a desired location. I.e., the ridge can be slid into a complementary trough or can be clamped or otherwise secured with clamps or other mechanisms. Additionally or alternatively, the attachment can include bolt holes, nuts, latches or any other desired attachment mechanism.

FIG. 6 also shows that the method 600 can include depositing 604 a first layer on the attachment. In at least one implementation, the first layer can nearest to the indicator. I.e., the first layer can be the brake pad material that will be the last to wear when the brake pad is in use. In particular, as the brake pad is worn down to the first layer, the brake pad is need of replacement.

FIG. 6 further shows that the method 600 can include adding 606 a visual indicator to the first layer. In at least one implementation, the visual indicator can include any material which is configured to alert the user about the state of brake pad wear. For example, first layer can include a dye or other visible material within the first layer. Additionally or alternatively, the visual indicator can include one or more cylinders or holes filled with a visual indicator within the first layer, such that when the first layer has been sufficiently worn, the visual indicator will be released and become visible.

FIG. 6 additionally shows that the method 600 can include depositing 608 a second layer on the first layer. In at least one implementation, the second layer can be thicker than the first layer. I.e., the second layer can be configured to provide the braking force for a majority of the brake pad life with the first layer indicating that the time is approaching to replace the brake pad. One of skill in the art can appreciate that the second layer can include the same material as the first layer.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A brake pad which provides a visual indication when the brake pad requires changing, the brake pad comprising:
a first layer, wherein the first layer includes a material configured to create friction with an external brake disk; and
a second layer, wherein the second layer includes
the material of the first layer; and
a dye, wherein the dye is configured to create a visually identifiable dust on the external brake disk.

2. The brake pad of claim 1 further comprising an attachment, wherein the attachment is configured to attach the brake pad to a braking system.

3. The brake pad of claim 2, wherein the attachment includes one or more bolt holes.

4. The brake pad of claim 3, wherein the attachment includes a ridge.

5. The brake pad of claim 4, wherein the ridge is configured to mate with a trough on the braking system.

6. The brake pad of claim 1, wherein the dye is embedded within the material of the second layer.

7. The brake pad of claim 1, wherein the dye is stored in cylinders within the second layer.

8. The brake pad of claim 1 further comprising a wear indicator.

9. The brake pad of claim 8, wherein the wear indicator includes a piece of metal.

10. The brake pad of claim 9, wherein the piece of metal is configured to make a noise when in contact with the external brake disk.

11. The brake pad of claim 9, wherein the piece of metal is configured to close an electric circuit and light a warning light.

12. A system for braking a wheeled vehicle, the system comprising:
a wear surface, wherein the wear surface is attached to a wheel;
a brake pad, wherein the brake pad includes:
a first layer, wherein the first layer includes a material configured to create friction with the wear surface; and
a second layer, wherein the second layer includes
the material of the first layer; and
a dye, wherein the dye is configured to create a visually identifiable dust on the wear surface; and
a brake caliper, wherein the brake caliper is configured to press the brake pad against the wear surface.

13. The system of claim 12, wherein the wear surface includes a disk.

14. The system of claim 13, wherein the disk includes at least one of:
a slot; or
a hole.

15. The system of claim 12, wherein the wear surface includes a drum.

16. The system of claim 15, wherein the caliper presses the brake pad against the exterior surface of the drum.

17. The system of claim 15, wherein the caliper presses the brake pad against the interior surface of the drum.

18. A method of manufacturing a brake pad which provides a visual indication when the brake pad requires changing, the method comprising:
providing a first layer, wherein the first layer includes
a material configured to create friction with an external brake disk connected to a wheel; and
a visual indicator, wherein the visual indicator is configured to create a visually identifiable dust on the external brake disk; and
depositing a second layer on the first layer, wherein the second layer:
includes the material of the first layer; and
does not include the visual indicator.

19. The method of claim 18, providing an attachment layer, wherein the attachment layer:
is configured to attach the brake pad to an external braking system; and
is attached to the first layer opposite the second layer.

20. The method of claim 18, wherein the visual indicator includes a dye.
